(19) United States
(12) Patent Application Publication
(10) Pub. No.: US 2017/0359572 A1
(43) Pub. Date: Dec. 14, 2017

(54) HEAD MOUNTED DISPLAY AND OPERATING METHOD THEREOF

(71) Applicant: SAMSUNG ELECTRONICS CO., LTD., Suwon-si (KR)

(72) Inventors: Myong-jo CHOI, Hwaseong-si (KR); Joon-hyun LEE, Seoul (KR); Dmitry Evgenievich PISKUNOV, Moscow region (RU); Jae-yeol RYU, Changwon-si (KR); Nikolay Viktorovich MURAVEV, Moscow region (RU); Jae-eun KANG, Suwon-si (KR); Byeong-hoon KWAK, Uiwang-si (KR)

(21) Appl. No.: 15/619,927

(22) Filed: Jun. 12, 2017

(30) Foreign Application Priority Data
Jun. 13, 2016 (KR) 10-2016-0073419

(51) Int. Cl. H04N 13/04; G02B 3/08; G02B 27/01

(52) U.S. Cl. CPC H04N 13/0497; G02B 27/0172; G02B 3/08; H04N 13/044

(57) ABSTRACT

A head mounted display includes: a display configured to display an image; a shutter configured to block light incident on an eye; a controller configured to control the display to display a left eye image and a right eye image using half or more of a region of the display in a horizontal direction and to control the shutter based on the image displayed on the display; and a lens configured to focus light output from the display such that the left eye image and the right eye image displayed on the display are viewed by a left eye and a right eye respectively.

### CROSS-REFERENCE TO RELATED APPLICATION

This application is based on and claims priority under 35 U.S.C. §119 to Korean Patent Application No. 10-2016-0073419, filed Jun. 13, 2016, in the Korean Intellectual Property Office, the disclosure of which is incorporated by reference herein in its entirety.

### BACKGROUND

### 1. Field

The present disclosure relates generally to a head mounted display and an operating method thereof.

### 2. Description of Related Art

While recent head mounted display related technology has been advanced, various technologies for improving the performance of a head mounted display has been developed.

An element that determines the performance of a head mounted display, in particular, an element that determines an optical characteristic includes an angle of view, brightness (luminance), and resolution, etc. In order to increase the angle of view, the size of a lens and the size of a display must be increased. In order to increase the brightness, a high brightness display must be used. Also, in order to increase the resolution, a high resolution optical system that uses the high resolution display and may display pixels of the high resolution display is needed.

To improve the optical characteristic, it is important to appropriately set each element according to an application. For example, even if the sizes of the lens and the display are increased, if a sufficient focal length is not secured, a wide angle of view may not be obtained, and, if a bulky waveguide is used to secure the sufficient focal length, a weight of the head mounted display is increased, which may cause inconvenience to the user.

Accordingly, there is a need for a head mounted display having improved optical characteristics while maintaining user convenience.

### SUMMARY

Head mounted displays capable of providing an image with a high resolution while maintaining user convenience and operating methods thereof are provided.

Additional aspects will be set forth in part in the description which follows and, in part, will be apparent from the description.

According to an aspect of an examplary embodiment, a head mounted display includes: a display configured to display an image; a shutter configured to block light incident on an eye; a controller configured to control the display to display a left eye image and a right eye image using half or more of a region of the display in a horizontal direction and to control the shutter based on the image displayed on the display; and a lens configured to focus light output from the display so that the left eye image and the right eye image displayed on the display are viewed by a left eye and a right eye respectively.

According to an aspect of an examplary embodiment, a method of operating a head mounted display includes displaying an image on half or more of a region of a display in a horizontal direction; and blocking light incident to an eye based on the displayed image.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example head mounted display according to an examplary embodiment;

FIG. 2 is a block diagram illustrating an example internal configuration of a head mounted display according to an examplary embodiment;

FIG. 3 is a diagram illustrating an example display that displays a left eye image on a half or more of a region according to an examplary embodiment;

FIGS. 4A and 4B are diagrams illustrating example optical paths of a head mounted display according to an examplary embodiment;

FIG. 5 is a diagram illustrating an example head mounted display having different an eye optical axis and an image optical axis according to examplary embodiments;

FIG. 6 is a diagram illustrating an example head mounted display that uses a plurality of lenses according to an examplary embodiment;

FIG. 7 is a flowchart illustrating an example method of operating a head mounted display according to an examplary embodiment; and

FIG. 8 is adiagram illustrating an example head mounted display according to another examplary embodiment.

### DETAILED DESCRIPTION

The various examplary embodiments will be described with reference to the accompanying drawings in such a manner that the embodiments may be easily understood by those of ordinary skill in the art. However, the disclosure may be implemented in various forms and is not limited to the examplary embodiments. For clarity of description, parts having no relation to description may be omitted. Like reference numerals are assigned to like elements throughout the present disclosure and the drawings.

It will be understood that when a region is referred to as being “connected to” or “coupled to” another region, it may be directly connected or coupled to the other region or intervening regions may be present. It will be understood that the terms “comprise”, “include”, and “have”, when used herein, specify the presence of stated elements, but do not preclude the presence or addition of other elements, unless otherwise defined.

In the present disclosure, a “left eye image” and a “right eye image” may refer, for example, respectively to an image incident to a left eye and an image incident to a right eye that have a binocular parallax in order to implement a 3D effect. Since left and right eyes of a human being are typically distant from each other by a distance of two eyes, when a specific object is viewed, images are formed at different positions on the left and right eyes, and such a position difference makes it feel the 3D effect. This is used to generate and display the “left eye image” and the “right eye image”, and thus a 3D image may be implemented.

In the present disclosure, an “interocular distance” may refer, for example, to a distance between pupils of the left and right eyes.

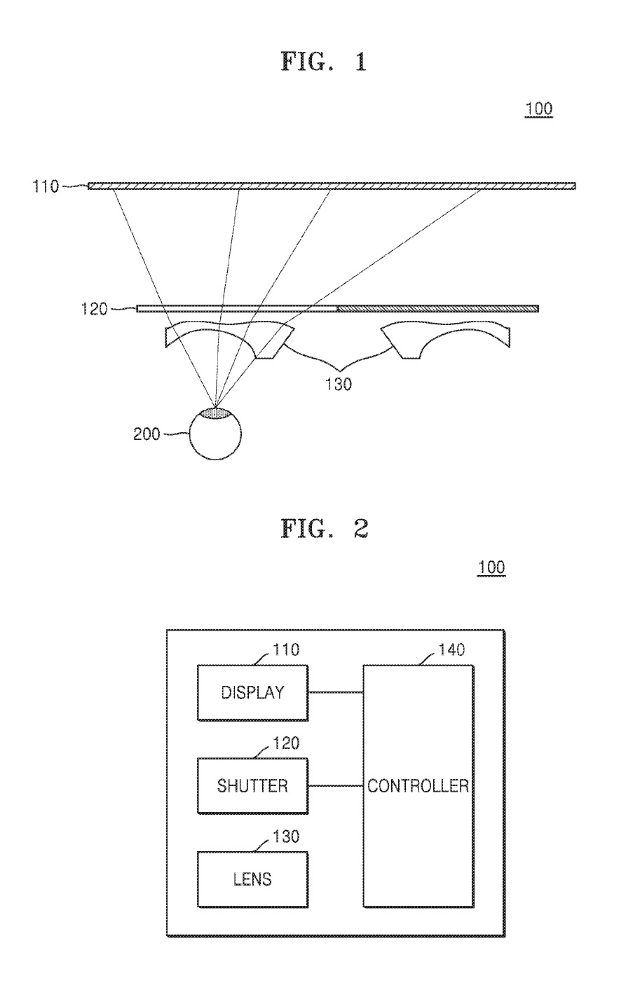

FIG. 1 is a diagram illustrating an example head mounted display 100 according to an examplary embodiment.

Referring to FIG. 1, light output from a display 110 is incident on an eye 200 via a shutter 120 and a lens 130.

In order to provide an image with a high resolution on a display, it is necessary to increase the number of pixels per unit region or to increase the size of a display itself. However, since the minimum size of a pixel of the display which may be manufactured at a current technology level is fixed, it is necessary to increase the size of the display itself to provide a high resolution image. However, when the size of the display is increased, a focal length generally increases. When the focal length is increased, an optical path becomes longer, the size of the head mounted display 100 becomes larger, and the weight is increased, thereby decreasing user convenience. Accordingly, there is a need for the head mounted display 100 capable of increasing the size of the display 110 to provide an image with a high resolution while minimizing and/or reducing a focal distance in consideration of user convenience.

FIG. 1 illustrates an example in which a left eye image is incident on a left eye.

The display 110 displays the left eye image using a half or more of a region of the display. According to an examplary embodiment, a large display 110 may be used to provide images at high resolution.

Since the left eye image is displayed on the display 110, the shutter 120 passes light incident on the left eye and blocks light incident on the right eye. For example, the shutter 120 may block the light incident on the right eye and the light incident on the left eye based on the image displayed on the display 110.

The lens 130 focuses the light output from the display 110 and transmits the light to the left eye so that the left eye image displayed on the display 110 may be viewed by the left eye. According to an examplary embodiment, by using the lens 130, a focal length may be minimized and/or reduced.

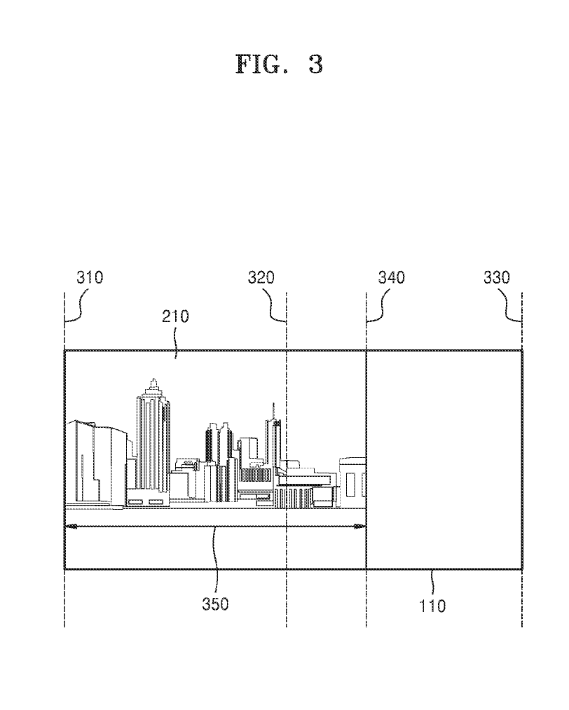

The head mounted display 100 will now be described in greater detail below with reference to FIGS. 2 through 7.

FIG. 2 is a block diagram illustrating an example internal configuration of the head mounted display 100 according to an examplary embodiment.

Referring to FIG. 2, the head mounted display 100 according to an embodiment includes the display 110, the shutter 120, the lens 130, and a controller (e.g., including processing circuitry) 140.

The display 110 displays an image under control of the controller 140. In an examplary embodiment, the display 110 may include at least one of a liquid crystal display, a thin film transistor-liquid crystal display, an organic light-emitting diode display, a flexible display, and an 3 electrophoretic display, or the like, but is not limited thereto.

In an examplary embodiment, the display 110 may be a display that is laterally longer than a predetermined interocular distance. Although there is a variation for each individual, in general, a distance between a person's eyes is about 65 mm. Thus, in an examplary embodiment, the display 110 may have a transverse length of at least 65 mm but is not limited thereto. The size of the display 110 may be determined by setting an interocular distance.

Further, if a focal length is not taken into account, the larger the size of the display 110 is, the more advantageous it is to provide a high resolution image with a wide angle of view. Thus, in an examplary embodiment, the display 110 may be the largest display mountable on the head mounted display 100. For example, when the display 110 is mounted in a housing (not shown), the display 110 may have a transverse length from a left end to a right end of the housing.

In an examplary embodiment, the display 110 may display a left eye image and a right eye image using a half or more of a region of the display in a horizontal direction under control of the controller 140. In an examplary embodiment, the half or more of a region may be a region from one end of the display 110 to a point between the center of the display 110 and the opposite end. For example, when displaying the left eye image, the half or more of a region may be a region from the left end of the display 110 to a point between the center and the right end of the display 110. Also, in an examplary embodiment, when displaying the right eye image, the half or more of a region may be a region from the right end of the display 110 to a point between the center and the left end of the display 110. This will be described with reference to FIG. 3.

FIG. 3 is a diagram illustrating an example display that displays a left eye image 210 on half or more of a region of the display according to an examplary embodiment.

Referring to FIG. 3, the left eye image 210 is displayed on an region 350 of the display from a left end 310 of the display 110 to a point 340 between a center 320 and a right end 330 of the display 110.

Although FIG. 3 illustrates the display 110 displaying the left eye image 210, the right eye image may also be displayed in the same manner. The right eye image may be displayed on a horizontally symmetrical region with respect to the region 350 where the left eye image 210 is displayed with respect to a center 320 of the display 110.

Referring back to the description of FIG. 2, in an examplary embodiment, the half of more of a region may be the whole region of the display 110. When displaying the left eye image or the right eye image using the whole region of the display 110, it is possible to provide an image with a resolution higher than that of displaying the left eye image or the right eye image using only a part of the region of the display 110.

When the left eye image and the right eye image are displayed by halving a display or there are a display for displaying the left eye image and a display for displaying the right eye image, an area for displaying the left eye image and the right eye image is limited or it is difficult to provide an image with a high resolution because of its limited size.

According to an examplary embodiment, the head mounted display 100 may provide an image at a high resolution by displaying a left eye image and a right eye image using a large area.

In an examplary embodiment, the display 110 may be a display in which a plurality of displays are horizontally elongated. However, in this case, it is preferable that a connection portion between displays is not shown to a user so that the user is not disturbed in viewing an image. In an embodiment, the plurality of displays may be connected directly without a border.

In addition, in an examplary embodiment, each of the left eye image and the right eye image is displayed in the half or more of a region of the display 110 in a horizontal direction, and thus the display 110 has a redundant region for displaying both the left eye image and the right eye image.

In an examplary embodiment, assuming that the image displayed on the display 110 is focused and delivered to both eyes, a higher resolution may be achieved as an area of the display increases. For example, if a length of the display increases by two in X and Y directions, the area of the display increases 4 times. If the area of the display is increased four times, a resolution two times higher in the X and Y directions may be obtained, respectively. However, in this case, a size of the optical system for focusing and transmitting images also increases. In the above example, when the optical system is doubled in the X, Y, and Z directions, a volume of the optical system is increased eight times. In an embodiment, a lens 130 is used to focus light output from the display to solve this problem. The lens 130 will be described in detail below.

The shutter 120 blocks light incident on the eye under control of the controller 140. In an examplary embodiment, the shutter 120 may block light incident on the right eye and light incident on the left eye according to the image displayed on the display 110 under control of the controller 140. For example, when the display 110 displays the left eye image, the light incident on the left eye passes through and blocks the light incident on the right eye. Further, when the display 110 displays the right eye image, the light incident on the right eye may be allowed to pass and the light incident on the left eye may be blocked. A signal for controlling the shutter 120 may be synchronized with a signal for displaying the left eye image and the right eye image.

In an examplary embodiment, the shutter 120 may be a transmittance variable shutter capable of adjusting the light transmittance. For example, the shutter 120 may adjust the light transmittance between 0% and 100%. However, in this case, it is not necessarily required to block 100% when blocking the light entering the right eye and the light entering the left eye according to the image displayed on the display 110. That is, it is also possible to block the light only to the extent that it does not interfere with the eyes to view an image.

In an examplary embodiment, the shutter 120 may split one shutter to block light entering the right eye and light entering the left eye. In addition, the shutter 120 may include two separate shutters, that is, a left eye shutter for blocking light incident on the left eye and a right eye shutter for blocking light incident on the right eye.

In an examplary embodiment, the shutter 120 may be positioned between the display 110 and the lens 130 or between the lens 130 and the eye 200. Further, when the lens 130 is a lens group composed of at least two lenses, the shutter 120 may be located between the lens included in the lens group.

According to an examplary embodiment, the head mounted display 100 may provide a stereoscopic image using the shutter 120 to adjust the left eye image to be incident on the left eye only, and the right eye image to be incident on the right eye only.

The lens 130 focuses the light output from the display 110. In an examplary embodiment, the lens 130 focuses light output from the display 110 so that the left and right eye images displayed on the display 110 may be viewed by the left and right eyes, respectively.

In an examplary embodiment, the lens 130 may be a free curved surface lens that is formed so that a refraction angle of a light output from a pixel of the display 110 which is farther away from the eye 200 becomes larger.

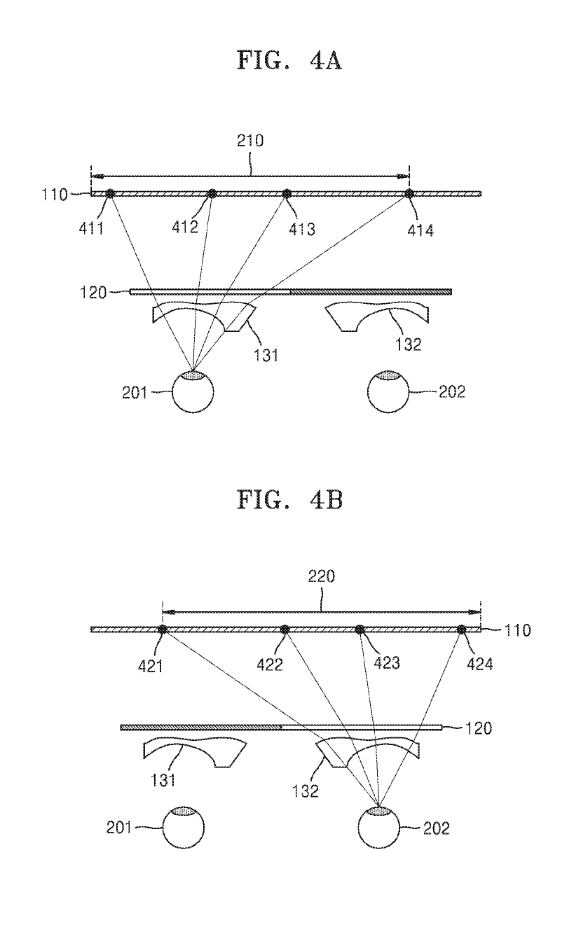

This will be described with reference to FIG. 4.

FIGS. 4A and 4B are diagrams illustrating example optical paths of a head mounted display according to an examplary embodiment.

FIG. 4A illustrates an optical path in which a left eye image 210 is displayed on the display 110, the shutter 120 blocks light incident on the right eye 202 and transmits light incident on the left eye 201, and the light output from the display 110 is incident on the left eye 201.

In FIG. 4A, with respect to an optical path of light output from pixels 411, 412, 413, and 414 of the display 110, a refraction angle may become larger as light output from a pixel far away from the left eye 201 increases. In other words, the lens 130 according to an examplary embodiment may be far away from the left eye 201 and refract the light of the display pixel with a larger angle of incidence.

According to an examplary embodiment, a focal length of the lens 131 may be reduced using a free curved surface lens that is formed such that a refraction angle becomes larger as the light output from the pixel of the display 110 which is distant from the eye increases. That is, a surface of the lens 131 may be appropriately processed so that light may be focused at a short focal distance by varying the refraction angle according to a position at which the light enters the lens 131. Therefore, according to an embodiment, even if a size of the display 110 itself increases or an area for displaying an image increases, a short focal distance may be maintained, and thus an image may be provided at a high resolution.

Further, in an embodiment, the lens 130 may be a free curved surface lens formed such that the incidence angle at which the light enters the eye increases as an exit angle of the light output from the pixel of the display 110 increases.

FIG. 4B illustrates an optical path in which a right eye image 220 is displayed on the display 110, the shutter 120 blocks the light incident on the left eye 201 and transmits light incident on the right eye 202, and a light path in which light output from the display 110 is incident on the right eye 202.

Like FIG. 4A, with respect to the light path of light output from pixels 421, 422, 423 and 424 of the display 110, a refraction angle may become larger as light output from a pixel far away from the left eye 201 increases.

Referring again to FIG. 2, in an embodiment, the lens 130 may include a left eye lens 131 for focusing light incident on the left eye and a right eye lens 132 for focusing light incident on the right eye. Also, the lens 130 may be a single lens that is connected long to the left and right.

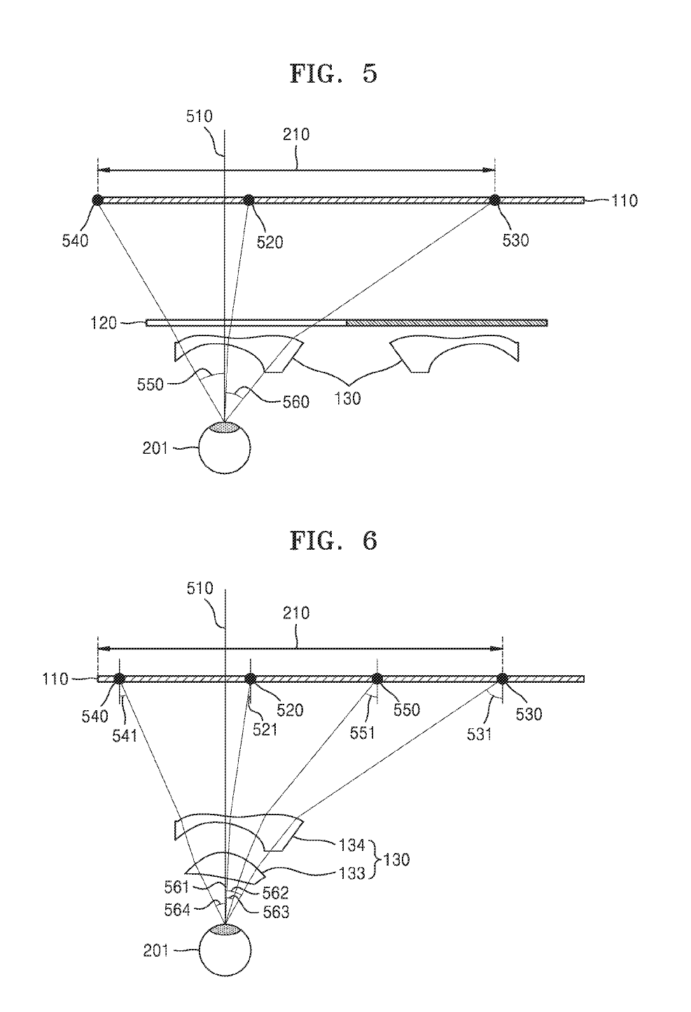

The lens 130 may also be a lens group composed of two or more lenses to focus the light output from the display 110. This will be described with reference to FIG. 6.

FIG. 6 is a diagram illustrating an example head mounted display that uses a plurality of lenses according to an examplary embodiment.

Referring to FIG. 6, the lens 130 is a lens group comprising a first lens 133 and a second lens 134. The first lens 133 is similar to a convex lens. The second lens 134 has a shape similar to a concave lens. An inclination of a center of an inner surface of the first lens 133 and an inclination of a tangent of a point where light output from a pixel located at a center of a left eye image meets an inner surface of the second lens 134 may be tilted toward inside eyes clockwise, e.g., seen from top.

In an examplary embodiment, when displaying the left eye image 210 on the display 110, the lenses 133 and 134 may be free curved surface lenses formed such that an incidence angle 564 of a first light output from a pixel 540 located to the left of a center 520 of the display 110 and incident to the left eye 201 is greater than an exit angle 541 of the first light, and incidence angles 561, 562, and 563 of a second light output from pixels 520, 530, and 550 located to the right of the center 520 of the display 110 and incident to the left eye 201 are smaller than exit angles 521, 531, and 551 of the second light. Also, in an examplary embodiment, when the right eye image 220 is displayed on the display 110, the lenses 133 and 134 may be free curved surface lenses formed such that an incidence angle of a third light output from a pixel located to the right of the center 520 of the display 110 and incident to a right eye 202 is greater than an exit angle of the third light, and an incidence angle of a fourth light output from a pixel located to the left of the center 520 of the display 110 and incident to the right eye 202 is smaller than an exit angle of the fourth light.

Referring back to the description of FIG. 2, furthermore, in an examplary embodiment, the lens 130 may be a Fresnel lens. According to an examplary embodiment, the Fresnel lens may be used to reduce a thickness of the lens 130.

The controller 140 may include various processing circuitry and controls all operations of the head mounted display 100, and in particular, may control a process of providing a user with high resolution images using the head mounted display 100. The controller 140 may include RAM that stores signals or data input from the outside of the head mounted display 100 or is used as a storage region corresponding to various operations performed by the head mounted display 100, ROM that stores a control program for controlling peripheral devices, and a processor. The processor may be implemented as a System On Chip (SoC) incorporating a core (not shown) and a GPU (not shown). The processor may also include a plurality of processors.

In an embodiment, the controller 140 may control the display 110 to alternately display the left eye image 210 and the right eye image 220. According to an embodiment, the left eye image 210 and the right eye image 220 are alternately displayed on the display 110, thereby giving a three-dimensional effect.

Also, in an embodiment, the controller 140 may control the shutter 120 to block the light incident on the right eye and the light incident on the left eye according to the image displayed on the display 110. At this time, the controller 140 may synchronize a signal for controlling the display 110 with a signal for controlling the shutter 120 to display the left eye image and the right eye image.

In an embodiment, when displaying the left eye image 210 on the display 110, the controller 140 may control the center of the left eye image 210 to be located on the right of an optical axis of the left eye 201 and when displaying the right eye image 220 on the display 110, control the center of the right eye image 220 to be located on the left of an optical axis of the right eye 202. This will be described with reference to FIG. 5.

FIG. 5 is a diagram illustrating an example head mounted display having different an eye optical axis and an image optical axis according to examplary embodiments.

Referring to FIG. 5, an optical axis 510 of the left eye 201 and a center 520 of the left eye image 210 do not coincide with each other. The center 520 of the left eye image 210 is located on the right side of the optical axis 510 of the left eye 201.

A right portion of the display 110 has a large area based on the optical axis 510 of the left eye 201 while a left portion of the display 110 has a small area. The larger the area of the display 110, the larger the number of pixels that may be seen in the left eye 201 per unit angle, that is, an angular resolution. Therefore, the angular resolution of the left portion of the optical axis 510 having a small area may be relatively low, and the angular resolution of the right portion of the optical axis 510 having a large area may be relatively high. Accordingly, in an examplary embodiment, the controller 140 may control the center of the left eye image 210 to be positioned to the right of the optical axis of the left eye 201 in order to increase the angular resolution of the left portion of the optical axis 510.

Even if the controller 140 adjusts a position of the center of the left eye image 210, the area of the right portion of the display 110 is large and the area of the left portion is small with respect to the optical axis 510 of the left eye 201, and thus a difference in the angular resolution may occur in the single display 110 depending on the position. In this case, the left eye image 210 displayed on the display 110 may be distorted.

In an embodiment, the controller 140 may correct the left eye image 210 and the right eye image 220 in consideration of a distortion caused by the lens 130, and control the display 110 to display the corrected left eye image and the corrected right eye image.

Also, according to an embodiment, there may be a difference in the angle of view between the inside and the outside of the eye due to an area difference. The right portion of the display 110 displaying the left eye image 210 on a larger area may have a relatively wide viewing angle 560 and the left portion of the display 110 displaying the left eye image 210 on a narrow area may have a relatively a small view angle 550.

Like the left eye, in case of the right eye, the controller 140 may control the center of the right eye image 220 to be located on the left of the optical axis of the right eye 202.

Further, although not illustrated in FIG. 1, the head mounted display 100 may include a memory (not shown). The memory may be installed and stored with various kinds of data such as programs and files, such as applications. The controller 140 may access the data stored in the memory and use the data or may store new data in the memory. Further, the controller 140 may execute a program installed in the memory.

According to an examplary embodiment, the head mounted display 100 capable of providing a high resolution image with a large wide angle of view may be provided.

Hereinafter, an operation method of the head mounted display 100 will be described.

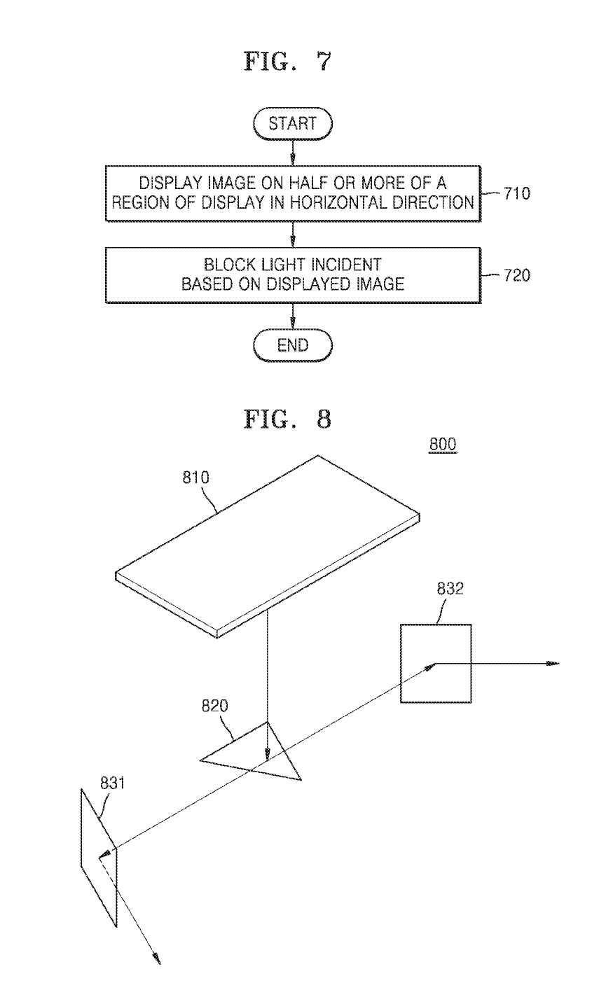

FIG. 7 is a flowchart illustrating an example method of operating a head mounted display according to an examplary embodiment. In describing FIG. 7, redundant descriptions with those described above will be briefly described.

First, in operation 710, the head mounted display 100 displays an image on a region of at least half of a display in a horizontal direction. In an embodiment, the head mounted display 100 may alternately display a left eye image and a right eye image. When the head mounted display 100 displays the left eye image, the left eye image is displayed from a left end of the display to a point between the center and the right end of the display, and when displaying the right eye image, the right eye image may be displayed up to a point between the center and the left end of the right eye.

Also, in an examplary embodiment, when the head mounted display 100 displays the left eye image on the display, the center of the left eye image may be located to the right of an optical axis of the left eye, and when displaying the right eye image on the display, the center of the right eye may be located to the left of the optical axis of the right eye.

Further, in an embodiment, the head mounted display 100 may correct the left eye image and the right eye image taking into consideration a distortion caused by a lens, and display the corrected left eye image and the right eye image.

Thereafter, in operation 720, incident light is blocked based on the displayed image. In an examplary embodiment, the head mounted display 100 may block light incident on the right eye when the display displays the left eye image, and may block light incident on the left eye when the display displays the right eye image.

According to an examplary embodiment, a method of operating the head mounted display 100 capable of providing a high resolution image with a large wide angle of view may be provided.

Meanwhile, the above described examplary embodiments may be embodied in the form of a computer readable recording medium storing computer executable instructions and data. At least one of the command and the data may be stored in the form of program code, and when executed by the processor, a predetermined program module may be generated to perform a predetermined operation.

The computer readable recording medium may be, for example, a magnetic storage medium such as a hard disk, an optical reading medium such as a CD and a DVD, or the like, and may be a memory included in a server accessible through a network. For example, the computer readable recording medium may be a memory of the head mounted display 100, or may be a memory included in a terminal, a server, or the like connected to the head mounted display 100 via a network.

FIG. 8 is adiagram illustrating an example head mounted display 800 according to another examplary embodiment.

Referring to FIG. 8, the head mounted display 800 according to another examplary embodiment includes a display 810, a beam splitter 820, and reflectors 831 and 832.

The display 810 is the same as or similar to the head mounted display 800 described above but is located at the top of the head mounted display 800, rather than being located on the front of the head mounted display 800.

The beam splitter 820 divides light output from the display 810. In an examplary embodiment, if the display 810 outputs the light, the beam splitter 820 serves to split the light to be transmitted to the left and right eyes. Referring to FIG. 8, the beam splitter 820 splits the light output from the display 810 located at the top of the head mounted display 800 to the left and right reflectors 831 and 832, respectively.

The reflectors 831 and 832 reflect the incident light and change a traveling direction. In an embodiment, the reflectors 831 and 832 may reflect light incident from the beam splitter 820 and change direction to be transmitted toward the eye.

Although not illustrated in FIG. 8, the head mounted display 800 according to another examplary embodiment may include a shutter, a lens, a controller, and the like similarly to the head mounted display 100 described above. However, the head mounted display 800 according to another examplary embodiment can secure a sufficient optical path by disposing the display 810 at the top of the head mounted display 800. Therefore, the lens of the head mounted display 800 may use a lens having a symmetrical shape other than a free curved surface lens.

It should be understood that the various examplary embodiments described herein should be considered in a descriptive sense only and not for purposes of limitation. Descriptions of features or aspects within each embodiment should typically be considered as available for other similar features or aspects in other embodiments.

While one or more examplary embodiments have been described with reference to the figures, it will be understood by those of ordinary skill in the art that various changes in form and details may be made therein without departing from the spirit and scope as defined by the following claims.

What is claimed is:

1. A head mounted display comprising:
a display configured to display an image;
a shutter configured to block light incident on an eye;
a controller configured to control the display to display a left eye image and a right eye image using half or more of a region of the display in a horizontal direction and to control the shutter based on the image displayed on the display; and
a lens configured to focus light output from the display so that the left eye image and the right eye image displayed on the display are viewed by a left eye and a right eye respectively.

2. The head mounted display of claim 1, wherein the lens comprises a free curved surface lens wherein a refraction angle becomes larger as light output from a pixel of a display eye increases.

3. The head mounted display of claim 1, wherein the half or more of a region of the display comprises a region from one end of the display to a point between a center of the display and an opposite end of the display.

4. The head mounted display of claim 1, wherein the controller is configured to control the display to alternately display the left eye image and the right eye image.

5. The head mounted display of claim 1, wherein the controller is configured to control the shutter to block light incident on the right eye when the display displays the left eye image and to block light incident on the left eye when the display displays the right eye.

6. The head mounted display of claim 1, wherein the lens comprises a Fresnel lens.

7. The head mounted display of claim 1, wherein the controller is configured to control a center of the left eye image to be located at the right with respect to an optical axis of the left eye when the display displays the left eye image and to control a center of the right eye image to be located at the left with respect to an optical axis of the right eye when the display displays the right eye.

8. The head mounted display of claim 1, wherein the controller is configured to control the display to correct the left eye image and the right eye image based on a distortion caused by the lens and display the corrected left eye image and right eye image.

9. The head mounted display of claim 1, wherein the shutter is disposed between the display and the lens or between the lens and the eye.

10. The head mounted display of claim 1, wherein the lens comprises a lens group comprising at least two or more lenses.

11. The head mounted display of claim 10, wherein the shutter is disposed between the at least two or more lenses included in the lens group.

12. The head mounted display of claim 1, wherein the display has a length longer than a preset interocular distance.

13. A method of operating a head mounted display, the method comprising:
displaying an image on half or more of a region of a display in a horizontal direction; and
blocking light incident on an eye based on the displayed image.

14. The method of claim 13, wherein the displaying of the image on half or more of a region of the display in the horizontal direction comprises:
alternately displaying a left eye image and a right eye image;
displaying the left eye image from a left end of the display to a point between a center of the display and a right end of the display when the left eye image is displayed; and
displaying the right eye image from a right end of the display to a point between the center of the display and a left end of the display when the right eye image is displayed.

15. The method of claim 13, wherein the blocking of the light incident on an eye based the displayed image comprises:
blocking light incident on the right eye when the display displays the left eye image; and
blocking light incident on the left eye when the display displays the right eye image.

16. The method of claim 13, wherein the displaying of the image on half or more of a region of the display in the horizontal direction comprises:
locating a center of the left eye image at the right with respect to an optical axis of the left eye when the display displays the left eye image; and
locating a center of the right eye image at the left with respect to an optical axis of the right eye when the display displays the right eye image.

17. The method of claim 13, wherein the displaying of the image on half or more of a region of the display in the horizontal direction comprises:
correcting the left eye image and the right eye image based on a distortion caused by the lens; and
displaying the corrected left eye image and right eye image.

18. A non-transitory computer readable recording medium having recorded thereon a program for performing the method of claim 13 on a computer.
